(19) United States
(12) Patent Application Publication
(10) Pub. No.: US 2003/0018509 A1
(43) Pub. Date: Jan. 23, 2003

(54) Network based work shift management system, software and method

(76) Inventors: David Ossip, Toronto (CA); Scott Morrell, Toronto (CA)

Correspondence Address: David P. Gordon, THE LAW OFFICES OF DAVID P. GORDON, 65 Woods End Road, Stamford, CT, 06905, US

(21) Appl. No.: 09/910,576

(22) Filed: Jul. 20, 2001

(51) Int. Cl. G06F 17/60

(52) U.S. Cl. 705/9

(57) ABSTRACT

A computerized, network based, work scheduling system, method and software are disclosed. The system includes a server and kiosks for use by employees of an organization. The system may allow employees to view work schedules including assigned work shifts. Employees may offer assigned shifts to others, so that they may be relieved of their shifts. Offered shifts are only made available to other qualified employees within the organization. Employers may authorize and track shift trades, and ensure that only qualified employees are allowed to assume an available shift.

### FIELD OF THE INVENTION

The present invention relates to managing work schedules, and more particularly to methods and devices for managing and allocating work shifts.

### BACKGROUND OF THE INVENTION

Most industries require members of their work force to agree to work specified hours. Often, a group of required working hours in one day are referred to as a work shift. In order to produce products or deliver services for most of each day, sufficient workers are often employed in order to fill shifts throughout the day.

Workers, on the other hand, often require flexibility in arranging their work schedules and their personal lives. As such, it is not uncommon for workers to have a desire to re-arrange their work schedules. Often, this is done by taking vacation or personal leave. Informally, many organizations additionally allow workers to exchange their responsibilities with others, thereby allowing the workers to fill in for others, or let others fill in for them.

As such, advertisements for shifts to be filled are often found on a bulletin board in a lunch room or other common gathering area. Workers wanting to avoid work on a given day and a given time advertise this desire by posting a paper slip. Workers willing to fill an advertised shift, typically in return for pay, or return for work at a different time, contact the advertisers.

This practice, however, is all too informal. Advertising workers only have access to workers that use the same cafeteria/gathering area; employers are uncertain of who will take particular shifts; employers have limited safeguards to assure that substitute workers are appropriate or have required skills.

Accordingly, an improved method and system allowing workers to trade and sell work shifts are desirable.

### SUMMARY OF THE INVENTION:

It is therefore an object of the present invention to provide a computerized work management system, allowing employees to trade shifts.

Advantageously, employees may make their shift available to all other qualified employees within an organization. Employers have the ability to track shift trades, and ensure that only qualified employees are allowed to assume an available shift.

In accordance with an aspect of the present invention, there is provided a computer implemented method of facilitating work allocation among employees within an organization. The method includes presenting a work schedule to a first one of the employees, including indicators of work shifts assigned to that employee; receiving input from that employee, an indicator of a desire to make a particular one of his/her work shifts available to other employees within the organization; presenting indicators of availability of this work shift to other employees within the organization having sufficient ability to substitute for the first employee; and receiving from one of the other employees an offer to assume this work shift.

In accordance with another aspect of the present invention there is provided a computer readable medium storing computer software for a work management system, that when loaded at computer server in communication with a data network, adapts the server to present a work schedule to a first employee, including indicators of work shifts assigned to the first employee; receive input from the first employee, indicative of a desire to make a particular one of his/her works shifts available to other employees within the organization; present indicators of availability of the particular one of the work shifts to other employees within the organization having sufficient ability to substitute for the first employee; receive from at least one of the other employees an offer to assume this work shift.

In accordance with yet another aspect of the present invention there is provided a work management system, located within the premises of an organization. The system includes a computer data network; a computer server in communication with the data network; a plurality of kiosks in communication with the data network. The server hosts a database storing employee work schedules. The kiosks are in communication with the server. The server is operable to allow an employee to post shifts for trade from one of the kiosks, and receive bids from other employees to assume posted shifts by way of the kiosks.

Other aspects and features of the present invention will become apparent to those of ordinary skill in the art, upon review of the following description of specific embodiments of the invention in conjunction with the accompanying figures.

### BRIEF DESCRIPTION OF THE DRAWING

In figures, which illustrate by way of example, embodiments of the present invention:

FIG. 1 illustrates a computerized work management system, including a plurality of kiosks, in communication with a network server, exemplary of an embodiment of the present invention;

FIG. 2 is a functional block diagram of software stored and executing at the network server of FIG. 1;

FIG. 3 is a diagram illustrating a database schema for a database used by the network server of FIG. 1;

FIGS. 4-6 illustrates exemplary steps performed at the server of FIG. 1; and

FIGS. 7-10 illustrate screens presented to employees by the server of FIG. 1 at kiosks of FIG. 1.

### DETAILED DESCRIPTION

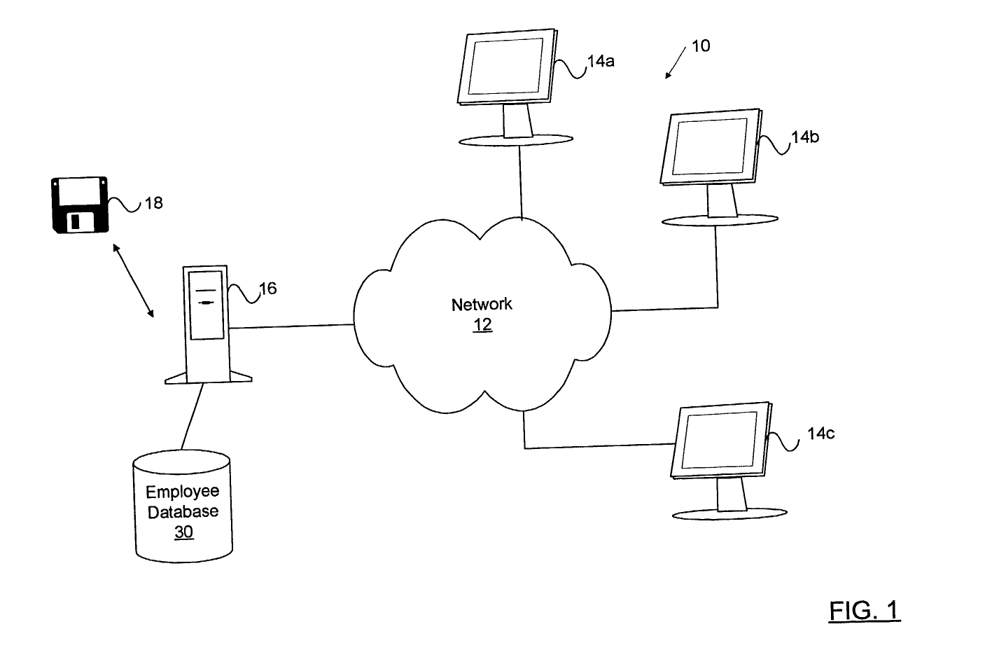

FIG. 1 illustrates a computerized work management system 10, exemplary of an embodiment of the present invention. As will become apparent, work management system 10 is preferably installed at the premises of an organization that employs employees that work in shifts. As used herein, the terms “employ” and “employee” are intended to extend to contractors, and others engaged on behalf of an organization or other person. The term “employer” is similarly intended to extend to any person or organization engaging employees. Shift, as used herein, is intended to refer to one or more block or blocks of time to be worked.

System 10 may, for example, be installed at a manufacturing facility, in an office, in a retail outlet, or the like. System 10 maintains work schedules of employees, and allows employees to monitor and potentially change their schedules. Supervisors/management of the employer may use system 10 to monitor employee work schedules, and collect information used in work scheduling, payroll, and other matters. Optionally, system 10 may be used by employees and supervisors/management to exchange workplace related electronic messages. Advantageously system 10 allows employees to trade work shifts in manners exemplary of an embodiment of the present invention.

Exemplary system 10 includes a computer network 12 in communication with user kiosks 14 and a computer server 16, exemplary of an embodiment of the present invention. Network 12 is preferably a private local area packet switched data network coupled to server 16. Network 12 may, for example, be an internet protocol, X.25, IPX compliant or similar network. Example user kiosks 14a, 14b and 14c (collectively and individually kiosk 14) are also illustrated. As will become apparent, kiosks 14 are adapted to communicate with server 16 in manners exemplary of the present invention. Optionally, network 12 may be in communication with the public internet. If so, any conventional computing device in communication with the internet may be able to communicate with network server 16 in manners exemplary of the present invention.

Example server 16 preferably includes a network interface physically connecting server 16 to data network 12, and a processor coupled to conventional computer memory. Example server 16 may further include input and output peripherals such as a keyboard, display and mouse. As well, server 16 may include a peripheral usable to load software exemplary of the present invention into its memory for execution from a software readable medium, such as medium 18.

As such, server 16 includes a conventional filesystem, preferably controlled and administered by the operating system governing overall operation of database server 16. This filesystem preferably hosts an employee database 30, hypertext transfer protocol (“http”) files; and software exemplary of an embodiment of the present invention, as detailed below. Server 16 provides information contained in this employee database 30 to requesting computing devices.

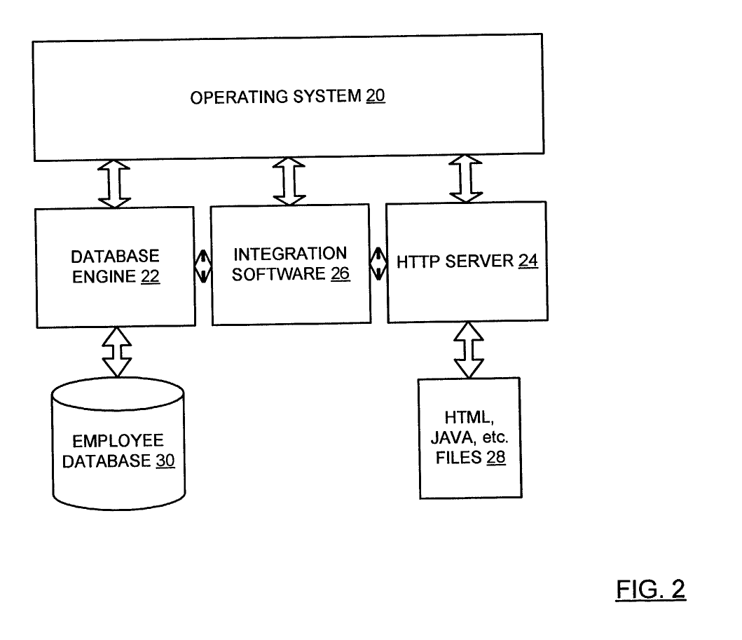

FIG. 2 illustrates a functional block diagram of software components preferably implemented at server 16. As will be appreciated, software components embodying such functional blocks may be loaded from medium 18 (FIG. 1) and stored within persistent memory at server 16. As illustrated, software components preferably include an operating system software 20; a database engine 22; an http server application 24; and integration software 26, exemplary of embodiments of the present invention. Further, database 30 is again illustrated. As well data files 28 used by integration software 26 and http server application 24 are illustrated.

Operating system software 20 may, for example, be Linux operating system software; Microsoft NT operating system software, or the like. Operating system software 20 preferably also includes a TCP/IP stack, allowing communication of server 16 with data network 12. Database engine 22 may be a conventional relational or object oriented database engine, such as Microsoft SQL Server, Oracle, DB2, Sybase, Pervasive or any other database engine known to those of ordinary skill in the art. Database engine 22 thus typically includes an interface for interaction with operating system software 20, and other application software, such as integration software component 26. Ultimately, database engine 22 is used to add, delete and modify records at database 30. Http server application 24 is preferably an Apache, Cold Fusion, Netscape or similar web server, also in communication with operating system 20 and database engine 22. Http server application 24 allows server 16 to act as a conventional http server, and thus provide a plurality of http pages for access by network interconnected computing devices. Http pages that make up these home pages may be implemented using one of the conventional web page languages such as hypertext mark-up language (“HTML”), Java, javascript or the like. These pages may be stored within files 28.

Integration software 26 adapts server 16, in combination with database engine 22 and operating system 20, and http server application 24 to function in manners exemplary of embodiments of the present invention. Integration software 26 may act as an interface between database engine 22 and http server application 24 and may process requests made by interconnected computing devices. In this way, integration software 26 may query, and update entries of database 30 in response to requests received over network 10, in response to interaction with presented web pages. Similarly, integration software 26 may process the results of employee input and database queries, and present results to database 30, or to employees by way of http pages. Integration software 26 may for example, be suitable CGI or Perl scripts; Java; Microsoft Visual Basic application, C/C++ applications; or similar applications created in a conventional ways by those of ordinary skill in the art.

Http pages provided to computing devices in communication with system 16 typically provide users at kiosks 14 with access to and information about work schedules, employment information, announcements and the like. Information may be stored as HTML or similar files 28. Conveniently, employees may make selections and provide information by clicking on icons and hyperlinks, and by entering data into information fields of the pages, presented at kiosk 14. As such, http pages are typically designed and programmed by or on behalf of the employer. Conveniently, the http pages may be varied as required by the employer.

Server 16 further preferably stores and executes an electronic mail server or similar application (not illustrated) that may be accessed through an HTML interface provided by http server application 24. For example, a simple mail transfer protocol (“SMTP”) compliant server application may be stored and executed at server 16. Alternatively, integration software 26 may include a messaging component that may allow employees to exchange electronic mail messages. So equipped, server 16 may additionally provide e-mail accounts for employee users of server 16. Suitable files storing messages that are sent, received, deleted, and archived may be formed on the file system of server 16. As will become apparent this server side e-mail application may be suitably integrated into system 10 by integration software 26.

As noted, server 16 is adapted to manage work scheduling, work allocation, and employee/employer interaction within an organization. Specifically, database 30 may store work schedules for each employee of the organization. Using these schedules, the managers or supervisors may review work allocation and track employees. Employees, on the other hand, may view their work schedules and re-arrange these using kiosks 14 in manners exemplary of embodiments of the present invention. Employers and employees may additionally similarly exchange electronic messages in known ways. Http server application 24 and integration software 26 allow access to database 30 remotely over network 12 using a conventional web browser and conventional web pages presented by server 16.

The architecture of kiosks 14 (FIG. 1) is not specifically illustrated. Each of kiosks 14 (FIG. 1), however, may be any suitable network aware computing device in communication with data network 12 and capable of executing a suitable HTML browser or similar interface. Most preferably, kiosk 14 is a conventional desktop computer including a processor, network interface, display, and memory. Preferably kiosks 14 are suitably encased, so that they may be installed in locations generally accessible by employees of an organization. Exemplary kiosks 14 are intended for occasional use by employees to obtain and exchange work related information. Kiosks 14, could, of course, be replaced by desktop computing devices provided at employee workstations.

Kiosks 14 may access server 16 by way of data network 12. As such, kiosks 14 typically stores and execute network aware operating systems including protocol stacks, such as TCP/IP stack, and internet web browsers such as Microsoft Internet Explorer™, Mozilla™, Netscape™, or Opera™ browsers. In order to limit use of kiosks 14, as intended by an employer, conventional software may be modified so that many of its conventional features are disabled.

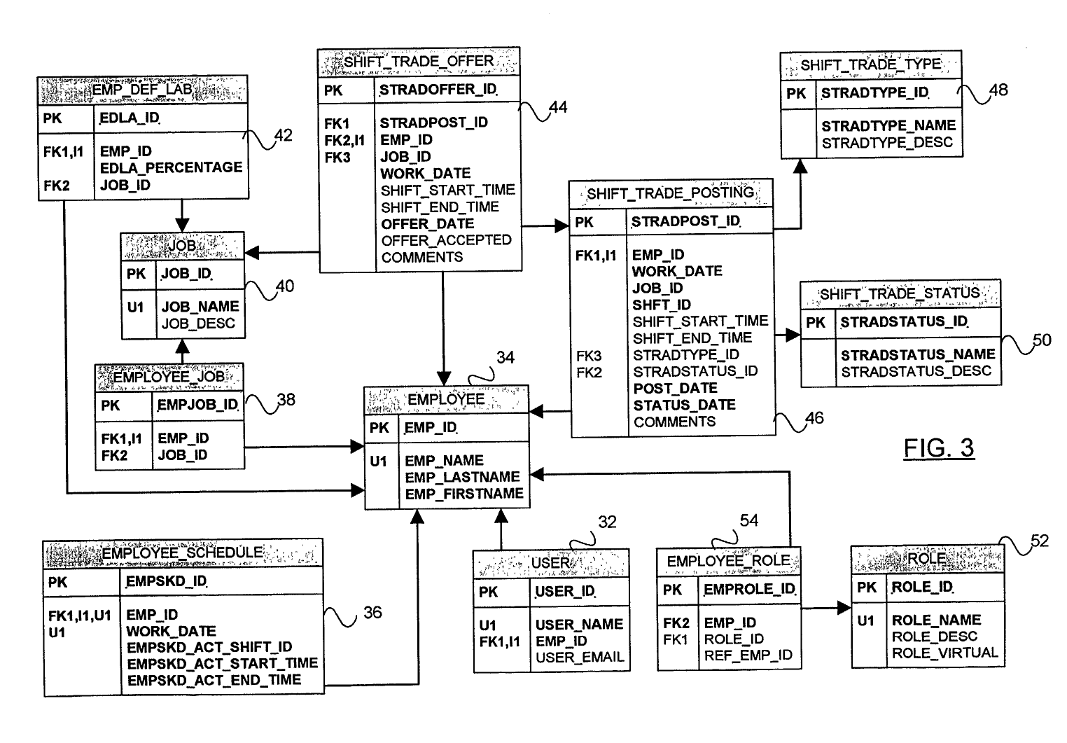

As noted, server 16 includes a database 30. Database 30 is preferably a relational database. As will become apparent, database 30 includes records for a plurality of employees served by server 16. A simplified example organization of database 30 is illustrated in FIG. 3. As illustrated, database 30 is organized as a plurality of tables. Specifically database 30 includes user table 32 (USER), employee table 34 (EMPLOYEE); employee schedule table 36 (EMPLOYEE_SCHEDULE); employee job table 38 (EMPLOYEE_JOB); organization job table 40 (JOB); employee default labour table 42 (EMP_DEF_LAB); shift trade offer table 44 (SHIFT_TRADE_OFFER); shift trade posting table 46 (SHIFT_TRADE_POSTING); shift trade type table 48 (SHIFT_TRADE_TYPE); shift trade status table 50 (SHIFT TRADE STATUS); employee role table 52 (EMPLOYEE_ROLE); and organization role table 54 (ROLE).

As noted, the illustrated structure of database 30 is simplified. Depending on the nature of additional features of system 10, that are not detailed herein, database 30 may include many more tables. Similarly, each illustrated table may include many more columns (or fields) than those detailed herein.

As illustrated, user table 32 includes columns (and therefore fields) for storing data representative of a user identifier (USER_ID); user name (USER_NAME); employee identifier (EMP_ID); and a user e-mail address (USER_E-MAIL). User table 32 stores records of users of system 10.

Employee table 34 includes columns (and therefore fields) for storing data representative of employee identifier (EMP_ID); employee name (EMP_NAME); employee last name (EMP_LASTNAME); and employee first name (EMP_FIRST_NAME). Employee table 34 stores records of users of system 10 that are employees.

Employee schedule table 36 includes columns associated with an employee's work schedule for storing data associated with an employee's work schedule. Fields include an employee schedule identifier (EMPSKD_ID); an employee identifier (EMP_ID); work date (WORK_DATE); an employee schedule shift identifier (EMPSKD_ACT_SHIFT ID); an employee schedule start time (EMPSKD_ACT_START_TIME); an employee schedule end time (EMPSKD_ACT_END_TIME). Employee schedule table 36 stores work schedules of employees identified in table 34.

Employee job table 38 includes an employee job identifier field (EMPJOB_ID); an employee identifier (EMP_ID); and a job identifier field (JOB_ID). Employee job table 38 stores information about jobs that employees identified in table 34 may fill.

Job table 40 includes a job identifier field (JOB_ID); a job name field (JOB_NAME); and a job description field (JOB_DESC). Job table 40 stores details about jobs within an organization.

Employee default labour table 42 includes columns representing an employee labour allocation identifier (EDLA_ID); an employee identifier (EMP_ID); and a job identifier (JOB_ID). Employee default labour table 42 stores information about the current job allocation of employees in employee table 34 to jobs in table 40.

Shift trade posting table 46 includes columns representing a shift trade posting identifier (STRADPOST_ID); and employee identifier (EMP_ID); work date (WORK_DATE); job identifier (JOB_ID); a shift start time (SHIFT_START_TIME); a shift end time (SHIFT_END_TIME); a shift trade type identifier (STRADTYPE_ID); shift trade status identifier (STRADSTATUS_ID); post date (POST_DATE); status date (STATUS_DATE); and comments (COMMENTS). Shift trade posting table 46 details shifts offered for trade.

Shift trade offer table 44 includes columns representing a shift trade offer identifier (STRADOFFER_ID); a shift trade post identifier (STRADPOST_ID); an employee identifier (EMP_ID); a job identifier (JOB_ID); a work date field (WORK_DATE); a shift start time (SHIFT_START_TIME); a shift end time (SHIFT END TIME); an offer date (OFFER_DATE); an offer accepted indicator (OFFER_ACCEPTED); and comments (COMMENTS). Shift trade offer table 44 details offers for posted shifts in table 46.

Shift trade type table 48 includes a shift trade type identifier (STRADTYPE_ID), a shift trade type name (STRADTYPE_NAME) and a shift trade type description (STRADTYPE_DESC). Shift trade type table 48 stores information about the nature of shift trades, and specifically if a shift has been traded in return for another shift (i.e. a shift swap), or if an extra shift has been assumed by an employee as a result of a trade.

Shift trade status table 50 includes a shift trade status identifier (STRADSTATUS_ID); and a shift trade status name (STRADSTATUS_NAME); and a shift trade status description (STRADSTATUS_DESC). Shift trade status table 50 stores information about the status of posted shift trades, and may indicate whether a trade is pending or has been approved.

Employee role table 54 includes an employee role identifier (EMPROLE_ID); an employee identifier (EMP_ID); a role identifier (ROLE_ID); a supervising employee identifier (REF_EMP_ID). Employee role table 54 stores information about an employee's current role (e.g. manager, worker, etc.) within an organization, as well an employee's supervisor.

Role table 52 includes a role identifier (ROLE_ID); a role name (ROLE_NAME); a role description (ROL_DESC). Role table 52 stores information about available roles within the organization.

Now, each user of system 10 is assigned a user identifier. A corresponding record within table 32 is created for the user, including this user identifier, and the user's true name. If the user is an employee, a unique employee identifier is assigned, and stored within the EMP_ID field of the user record in table 32. This unique identifier is used to identify associated records within the remaining tables of database 30. A corresponding employee record for this user/employee is created in the employee table 34. This record is further populated with the employee's name. As will be appreciated, database 30 may be updated by an employer each time a user/employee joins or leaves an organization, or when there is a change in circumstances.

Depending on the employee's skills, one or more records within the employee job table 38 are created for each employee. Each record identifies a particular job within the organization that an identified employee may be filled. The employee is identified by EMP_ID, and the job is identified in the JOB_ID field. The EMP_ID corresponds to the employee identifier in employee table 34. The JOB_ID corresponds to a job within the organization detailed in job table 40. Depending on the nature of the employee's skills several records within table 38 may be created. As an employee's skills improve over time, records identifying the employee and his or her acquired skills may be added to employee job table 38.

Job table 40 identifies classified jobs within an organization. Table 40 may identify the job by name and description.

Employee schedule table 36 contains records corresponding to an employee's schedule for each day. Each record within table 36 corresponds to one employee's work schedule for one day. Again, the employee is identified by an employee identifier in the EMP_ID field. This corresponds to an employee for whom a record exists within employee table 34. Start and stop times are further included within the record.

An employee's current job assignment (i.e. an identifier of the employee's current job among possible jobs) within the organization is identified by a record within table 42. Again, the employee is identified within the record by his or her unique employee identifier. The job is identified in the record, and corresponds to a job within the organization.

An employee's role as supervisor or subordinate is additionally stored within a record of employee role table 54. The employee's immediate supervisor is identified by the REF_EMP_ID field within role table 52. The supervisor is preferably identified by his or her employee id. A corresponding record for the supervisor exists within table 34. Available roles within the organization are stored within table 52.

So, the combination of entries within tables 32, 34, 36, 38, 40, 42 uniquely define an employee's work schedule within an organization. Queries of these tables for a particular employee identifier will identify an employee's job skills; and work schedule (including assigned shifts). The employee's role and supervisor within the organization are detailed in records within tables 52 and 54.

Database 30 may be updated as required by an employer. It may be updated manually, or by suitable scripting software, not detailed herein that may optimize or otherwise allocate shifts and the like.

As will become apparent, employee shifts available for trade are recorded within table 46. Bids to assume these shifts are recorded within table 44.

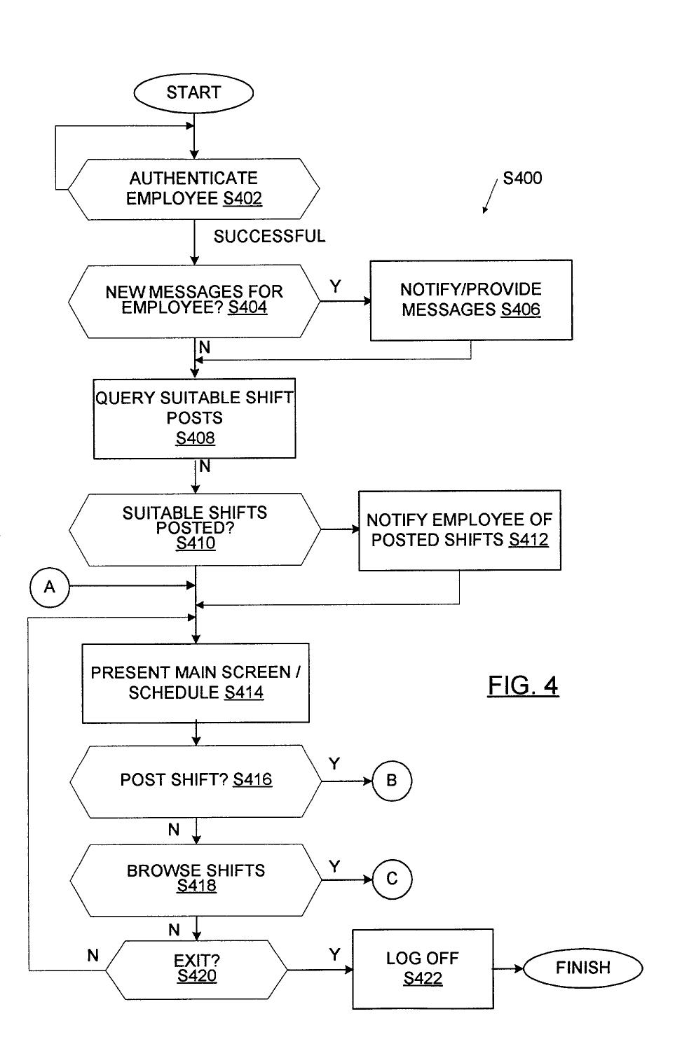

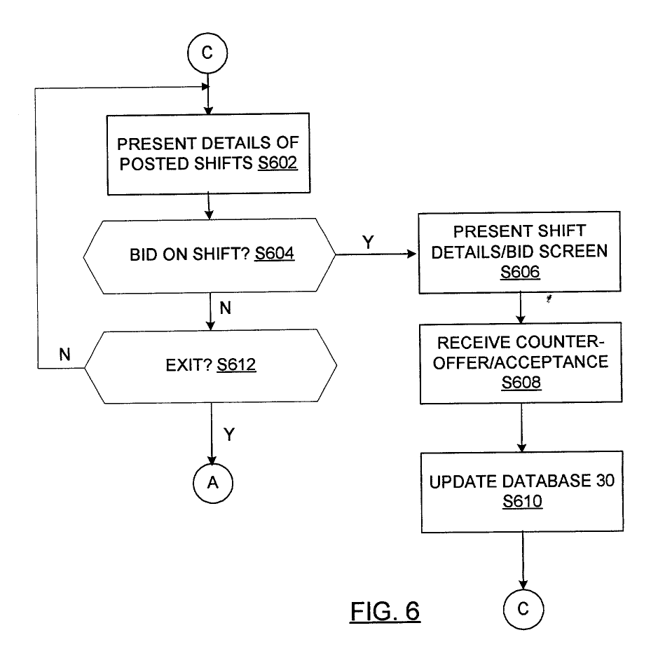

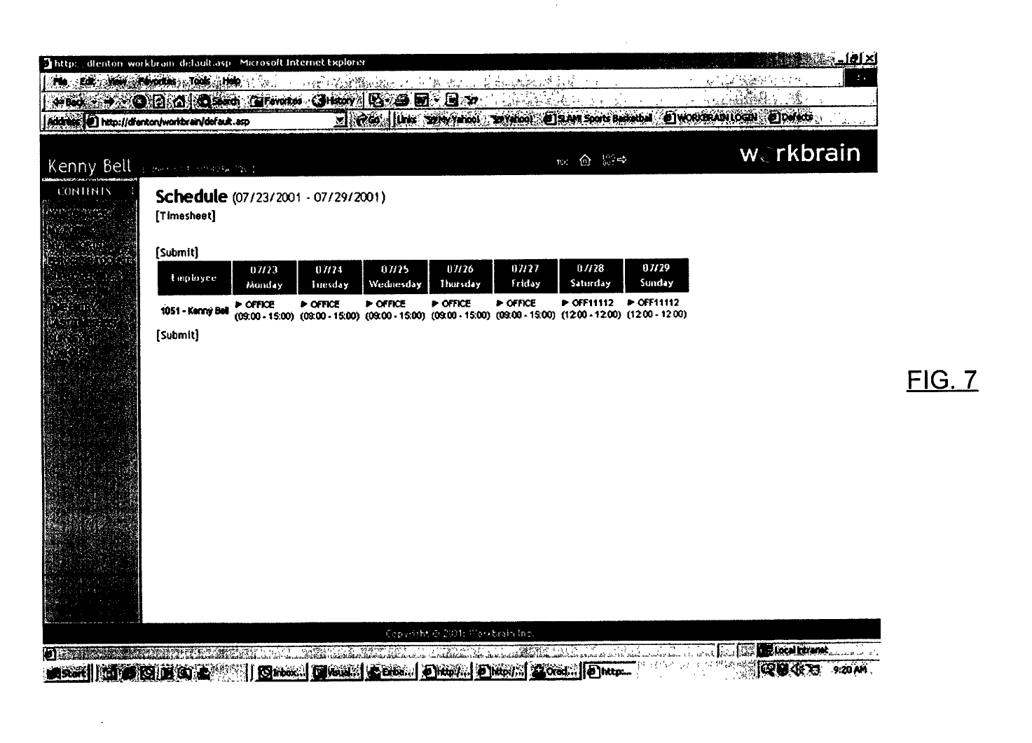

In operation, an employee may use any one of kiosks 14 (FIG. 1) to view information about the employee's work profile. To do so, the employee may use a web browser at the kiosk 14, to establish a session with server 16. Example steps taken at server 16 in response to interaction with an employee at one of kiosks 14 are detailed in FIGS. 4-6. Example screens presented to the employee are illustrated in FIGS. 7-10. Specifically, upon initial contact by an employee, http server application 24 at server 16 provides the browser software at kiosk 14 with a log-in prompt by providing a suitable HTML form stored within files 28 at server 16. This form allows the employee to identify and/or authenticate himself or herself in step S402.

Once authenticated, server 16 is aware of the employee's unique id, as stored within database 30. Server 16 under control of integration software 26 and using the employee id checks for new messages directed to the particular employee in step S404. For example, integration software 26 may query the e-mail server application hosted at server 16 to determine if any new messages have arrived for the logged-in employee. If so, the employee may be suitably notified by being presented with an HTML page, or the like in step S406.

Next, in step S408, server 16 uses the identification of the employee to query if any shifts suitable to the employee have been made available for trading, or “posted”. Specifically, table 46 may be queried for entries having job identifiers corresponding to those associated with the logged-in employee. As noted, appropriate jobs for the employee are stored within employee job table 38. If matches exist, as determined in step S410, the employee is notified of the posted shifts in step S412. The employee may be presented with a prompt or HTML page identifying the available shifts. As will become apparent, the employee is given the option of viewing available posted shifts and bidding on these in steps S600 and onwards, as also detailed below.

Further, in steps S414 and onward, the employee is presented with a main menu presenting the employee with a variety of options. The employee may, for example, originate e-mail messages to others within the organization; view facilities information, including for example, a map, hours of operation and the like. These features are not detailed herein.

More significantly, the employee may view his/her work schedule by pressing a suitable HTML link on a presented screen in step S414. This request is provided to server 16, which in turn under control of integration software 26 generates a suitable query to database 30 using engine 22, and forms an HTML page presenting a main menu and the employee's work schedule on screen 700, as illustrated in FIG. 7. As illustrated, the main menu is formed as frame 702 within a presented window. Conveniently, this frame may be present for all presented screens.

The query may query table 36 for the employee's daily schedule for dates of interest. This HTML page is presented to the user at kiosk 14. Specifically, http server application 24 provides the HTML data for presentation by the web browser at kiosk 14. Optionally, the employee may view his/her schedule as a calendar.

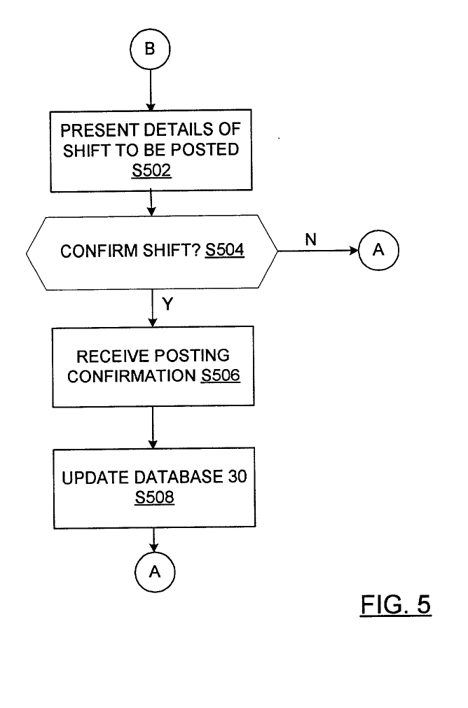

Now, in manners exemplary of the present invention, the employee may also choose to make one or more of his work shifts available to other employees in step S416. A shift that is to be made available to others is said to be “posted”. This may be effected by clicking an appropriate link from the main menu screen, or from screen 700 (FIG. 7). Thereafter steps S500 illustrated in FIG. 5 are performed.

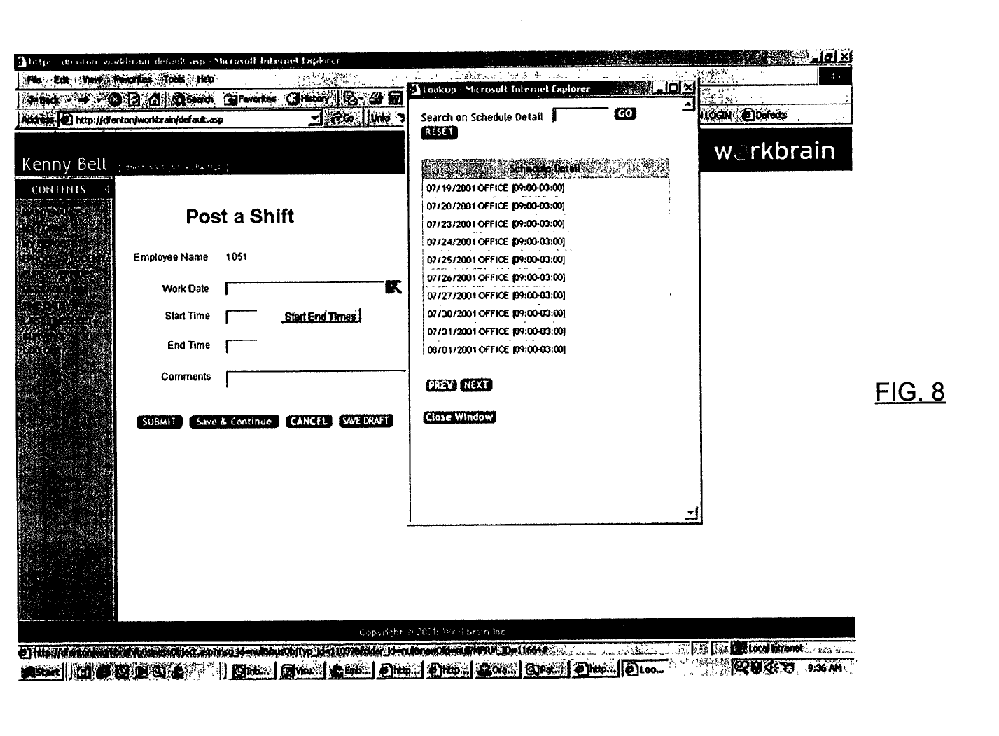

Specifically, in step S502 the employee is presented with a suitable screen 800, as illustrated in FIG. 8, that the employee may use to identify and confirm the shift that he/she wishes to post. He or she may do so by either by entering text data identifying the shift, or by clicking on the shift as presented on an HTML screen. If confirmed in step S504, server 16 is provided with an indicator that the particular shift is to be posted for trade in step S506. In response, in step S508, software 26 at server 16 generates a record (entry) in the SHIFT_TRADE_POSTING table 46 of database 30, indicative of the posted shift. Fields identifying the employee (EMP_ID); date of the posted shift (WORK_DATE); job type (JOB_ID); shift identifier (SHIFT_ID); shift start and end time (SHIFT_START_TIME; SHIFT_END TIME); post date (POST_DATE); and status date (STATUS_DATE) are populated with appropriate information about the posted shift and employee, in response to receiving the indicator in step S508. The appropriate information may be received input by the employee, or parsed from user interaction with the employee's presented schedule. As well, a record within shift trade status table 50 may be created indicating that the shift trade is pending and has not been completed.

Optionally, server 16 may prevent postings of shifts that are too close in time, or in the too distant future. For example, server 16 may prevent posting of shifts that will occur within 48 hours. Similarly, integration software 26 may limit posting of shifts based on employer defined rules. For example, an employer may prevent posting of shifts on identified days.

After posting of a shift is complete, server 16 again performs steps S414 (FIG. 4), and onward.

In addition to posting shifts, an employee may view posted shifts of others. Specifically, as noted, in step S406-S412, upon log-in server 16 may present to a user at one of kiosk 14 an indicator that work shifts are available for bidding. Server 16 does this by first querying employee job table 38 of database 30 for posted jobs of the type JOB_ID of the job types associated with the logged in employee. That is, database 30 is queried for entries within SHIFT_TRADE_POSTING table 46, having job identifiers (JOB_ID) corresponding to that of the logged in employee. As each employee may have many associated job types, such a query should return all posted jobs that may be assumed by the logged-in employee.

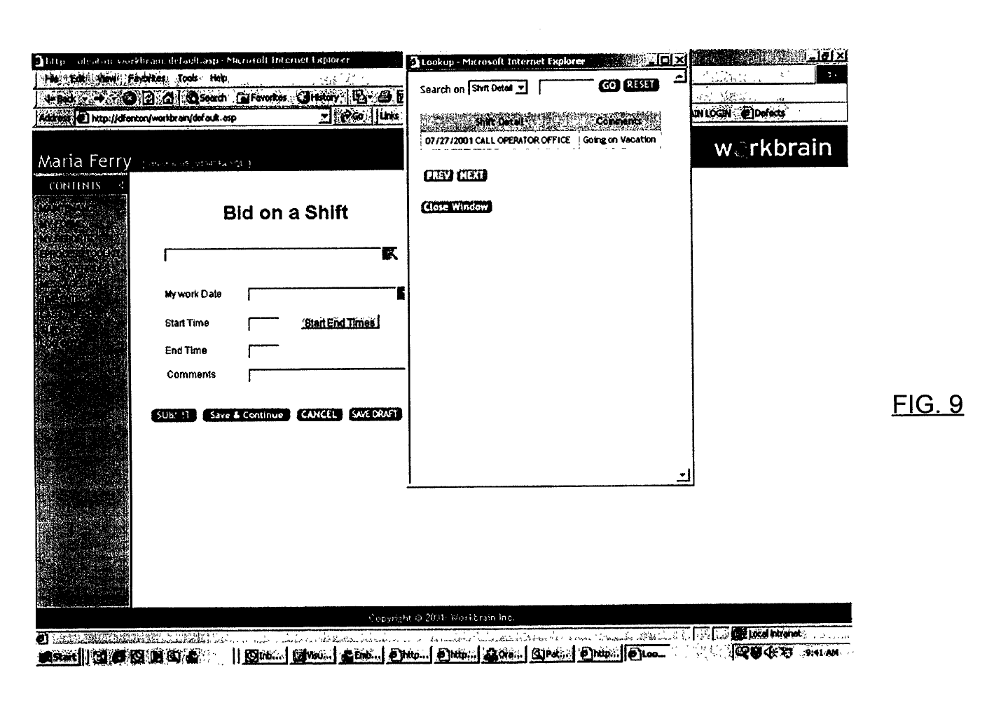

Entries within SHIFT_TRADE_POSTING table 46 matching the query, if any, may be retrieved, an indicator of the matches may be presented to the employee in step S410. The actual matches could also be presented to the logged-in employee for consideration, at this time. In the preferred embodiment, however, the matches are presented in steps S600, upon selecting an appropriate link in step S414. Optionally, the query performed in step S408 could be performed at this time. Again, matches may be presented to the employee at kiosk 16 as a suitable HTML form in step S602 generated by HTTP server application 24 in cooperation with database engine 22, and integration software 26. Alternatively, the retrieved shifts may be presented in an separate window, for browsing by the employee. So presented, the employee may browse posted shifts. An example screen 900 presenting posted shifts available for bidding by an employee is illustrated in FIG. 9.

Once presented with suitable matches, the employee may bid on a particular posted shift, by clicking on an identifier of the shift. This desire to bid on a shift and an indicator of the shift is presented to server 16 in step S604. In order to bid, the employee may be presented with an appropriate HTML screen 900 to be populated in step S606. Again, the form may be presented by http server application 24, in cooperation with database engine 22, and integration software 26. The employee may populate the form by indicating acceptance of the offered shift on the terms set by the offering employee, or by presenting a counter-offer. For example, the employee may offer to take the posted shift, if the posting employee agrees to assume another shift. Counter-offers may be presented implicitly. A bidding employee wishing to assume one shift may by implication require the posting employee to assume the bidding employee's shift on the day of the posted shift. As such, if the bidding employee accepts such an offer, the shift trade will result in an exchange or swap of shifts. In any event, once populated, the data in the form is returned to server 16, in step S608.

Optionally, server 16 may query the bidding employee's work schedule (steps not illustrated) by querying table 36 to ensure no conflict between the bidding employee's work schedule and the bid-upon shift. If a conflict exists, the bidding employee may be notified, and the bid need not be recorded. Again an employer may set rules permitting or allowing certain bids. For example, a bidding employee may be prevented from assuming more than one shift in a day, or a set number in a week or other interval.

If a bid is to be recorded, a record within SHIFT_TRADE_OFFER table 40 of database 30 is generated and populated with an identifier of the bid-upon shift and date (STRADPOST_ID field), as well as an identifier of the bidding employee (EMP_ID field) in step S610. An offer of acceptance may be noted in the OFFER_ACCEPTED field of the record of the posted shift in shift trade posting table 46. Additionally, a message notifying the posting employee of the bid/counter-offer/offer of acceptance is generated. Server 16 may do this by generating a notification e-mail message reflecting the offer/counter-offer to accept a posted bid using entries within shift trade offer table 44, also in step S610.

Upon completion of a bid, the employee may continue to browse posted shifts. Step S602 and onward are repeated. Once an employee no longer wishes to bid, as determined in step S604, he or she may exit from the bidding screen as determined in step S612 and be returned to the main screen presented in step S414 (FIG. 4).

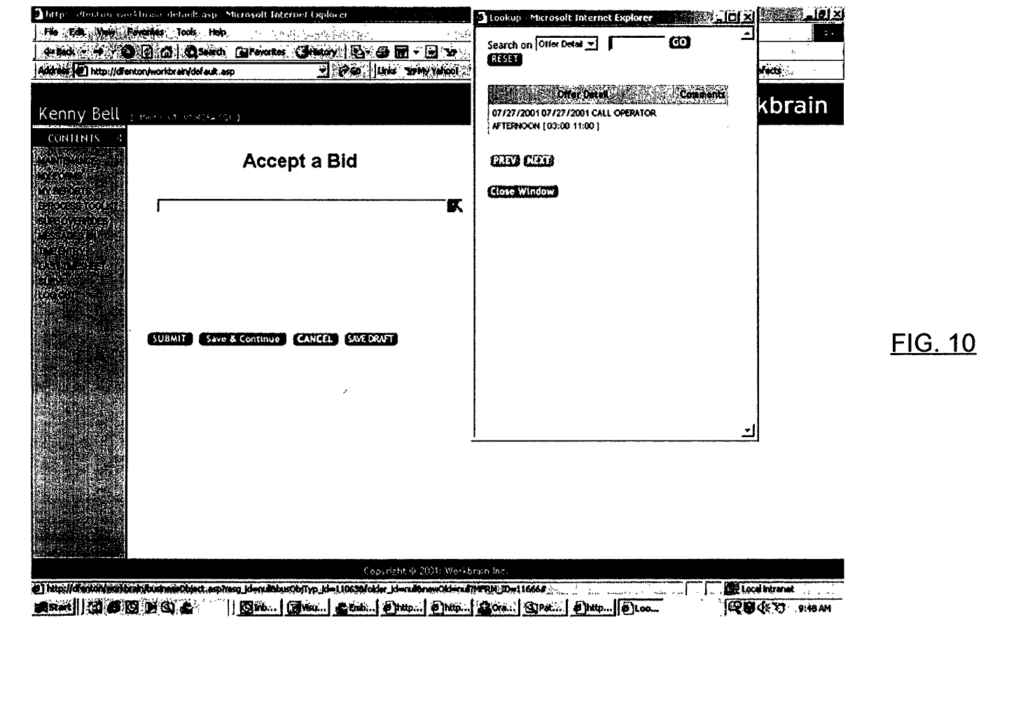

Upon future log-in by the posting employee, server 16 notifies the employee if any shifts previously posted by the now logged-in posting employee have been bid upon. This may be effected, by database engine 22 querying table 46 for bids posted by the posting employee, having been bid upon. A notification e-mail may, for example, be presented to the posting employee in step S404. The e-mail may further contain a link to an HTML screen 1000 allowing the posting employee to accept the bid, as illustrated in FIG. 10. Conveniently, if multiple bids are presented, the posting employee will be notified of each of the offers and may choose the most attractive bid.

Now, once a posted shift has been bid upon, and the bid has been accepted, the potential shift trade is preferably presented to a supervisor for authorization. Specifically, software 26 queries table 54 for supervisors of the posting and offering employee. E-mails identifying the potential shift may be forwarded to the supervisors so identified. These supervisors may be presented with HTML forms requiring approval of the shift trade (not shown). Once the shift trade is approved the associated shift trade status record within table 50 may be updated. If the potential shift trade is not approved, the posting and bidding employees may be notified, again preferably by e-mail.

Advantageously, if the initial potential shift trade is not approved, the posting employee may then accept any other outstanding bids. Once a shift trade is authorized, the work schedules of the posting employee and the successful offering employee are updated to reflect the traded shift. That is table 36 may be updated for both the posting and offering employee. As well, the shift trade type may be recorded in table 48. That is, whether the shift trade involves a swap of shifts or simply an assignment may be recorded.

Optionally, prior to presentation of a potential shift trade to a supervisor, software at server 16 may analyze the bidding employee's work record to ensure that no traded shifts have been missed; to determine if a posting employee has exceeded a maximum amount of work in a given interval (e.g. in a day, week or month); or to make other assessments of the offering employee. A supervisor, prior to being requested to approve a shift trade may be presented with relevant information so that this may be factored into a decision of whether or not to approve the shift trade.

Upon next log-in by the posting employee or the bidding employee, server 16 notifies the employees of the changed schedule. Again, this may be effected as a result of software 26 generating e-mail messages to be sent to the posting and bidding employees. In order to ensure that responsibility for the posted shift is properly assigned, software 26 may wait until the bidding employee has been notified before re-assigning the shift and notifying the posting employee. As well, the employees' schedules, when viewed, would reflect the traded shift.

Advantageously, server 16 presents posted shifts to other employees only if those employees have the job skills required for the posted shift (as for example determined in step S408). Similarly, server 16 makes posted shifts available to all employees within an organization capable of filling the shift. Further, any shift postings and offers of acceptance may be logged by server 16. As such, shift postings, offers and trades may be analyzed by server 16. Moreover, as any shift trade is preferably authorized by one or more supervisors, shift trades may be monitored by management or by supervisors. In this way, potentially problematic shift trades may be manually denied by supervisors. Finally, as traded shifts are logged by system 10, and work schedules are updated, responsibility for a missed shift may be effectively transferred to an employee who has successfully bid on a shift. Thus, if the successful bidding employee misses the shift, he or she may be held accountable. Personnel records could be updated, and future shift trading privileges could be limited. As well, organization payroll records may be updated to reflect that shifts have been traded.

As will be appreciated, while the organization of software functional blocks, database structure, screens and http/HTML pages, and servers have been illustrated as clearly delineated, a person skilled in the art will appreciate that the delineation between software blocks and screens, as well as the organization of hardware embodying the invention is somewhat arbitrary. Numerous other arrangements of hardware, screens and software blocks are possible. For example, server 16 could be replaced with a plurality of servers in communication with each other: one server could host a database; another http server; and yet another an e-mail application. Database 30 could be replaced by an object-oriented database.

Of course, the described embodiments are intended to be illustrative only, and in no way limiting. These embodiments are susceptible to many modifications of form, arrangement of parts, and details and order of operation. The invention, rather, is intended to encompass modifications within its scope as defined by the claims.

What is claimed is:

1. A computer implemented method of facilitating work allocation among employees within an organization comprising:
presenting a work schedule to a first one of said employees, including indicators of work shifts assigned to said first one of said employees;
receiving input from said first one of said employees, indicative of a desire to make a particular one of said work shifts assigned to said first one of said employees available to other employees within said organization;
presenting indicators of availability of said particular one of said assigned work shifts to other employees within said organization having sufficient ability to substitute for said first employee;
receiving from one of said other employees an offer to assume said particular one of said assigned work shifts.

2. The method of claim 1, further comprising assigning said particular work shift to said one of said other employees, as a consequence of said offer.

3. The method of claim 2, further comprising seeking approval of said assigning prior to said assigning from a supervisor.

4. The method of claim 2, further comprising receiving an indicator of an acceptance of said offer by said first one of said employees.

5. The method of claim 1, further comprising identifying employees having sufficient ability to substitute for said first employee by querying a database containing job identifiers of said first employee, and other employees.

6. The method of claim 5, wherein said indicators are only provided to employees having like job descriptions within said organization.

7. The method of claim 2, wherein said offer comprises a counter-offer.

8. The method of claim 7, wherein said counter-offer comprises a request to trade said particular work shift for another shift assigned to said one of said other employees.

9. A computer readable medium storing computer software for a work management system, that when loaded at computer server in communication with a data network, adapts said server to
present a work schedule to a first employee, including indicators of work shifts assigned to said first employee;
receive input from said first employee, indicative of a desire to make a particular one of said works shifts assigned to said first employee available to other employees within said organization;
present indicators of availability of said particular one of said work shifts to other employees within said organization having sufficient ability to substitute for said first employee;
receive from at least one of said other employees an offer to assume said particular one of said assigned work shifts.

10. A work management system, located within the premises of an organization, said system comprising:
a computer data network;
a computer server in communication with said data network;
a plurality of kiosks in communication with said data network;
said server hosting a database storing employee work schedules;
said kiosks in communication with said server;
said server operable to allow an employee to post shifts for trade from one of said kiosks, and receive bids from other employees to assume posted shifts by way of said kiosks.
